(19) United States
(12) Patent Application Publication
(10) Pub. No.: US 2026/0363279 A1
(43) Pub. Date: Nov. 19, 2026

(54) METHOD FOR PRODUCING GRILLED FISH HAVING IMPROVED TEXTURE

(71) Applicant: CJ CHEILJEDANG CORPORATION, Seoul (KR)

(72) Inventors: Soyoung YOON, Seoul (KR); Minkyu JEONG, Seoul (KR); Jihyun KANG, Seoul (KR); So Young JEON, Seoul (KR); Hyo-Jung JUNG, Seoul (KR); Jin Woo PARK, Seoul (KR)

(73) Assignee: CJ CHEILJEDANG CORPORATION, Seoul (KR)

(21) Appl. No.: 19/126,179

(22) PCT Filed: Oct. 6, 2023
(86) PCT No.: PCT/KR2023/015427

§ 371 Date: Apr. 30, 2025

(30) Foreign Application Priority Data
Oct. 31, 2022 (KR) 10-2022-0142808

(51) Int. Cl. A23L 5/10; A23B 2/80; A23L 5/20

(52) U.S. Cl. CPC A23L 5/13; A23B 2/80; A23L 5/276

(57) ABSTRACT

The present disclosure relates to a method of preparing grilled fish, the method including the step of pretreating the fish with an alkaline agent, and grilled fish, which is prepared by the method.

### TECHNICAL FIELD

The present disclosure relates to a method of preparing grilled fish, the method including the step of pretreating the fish with an alkaline agent, and grilled fish prepared by the method, which has improved texture while being suitable for cold chain due to mass production.

### BACKGROUND ART

Processed seafood products are produced by applying appropriate heat treatment to various seafood raw materials for cooking and securing safety. Stronger heat treatment is required to ensure preservation, but such heat treatment causes a significant quality deterioration in terms of color and physical properties unique to seafood raw materials. In particular, in the case of grilled fish, which has a high frequency of eating and high consumer's preference among various processed seafood products, many different products have been recently commercialized. However, due to the above problems, there are not many products having excellent appearance and texture quality while securing the expiry date suitable for cold chain due to mass production. It is necessary to technologically overcome these issues and to provide more valued products for consumers.

Generally, grilled fish is prepared by removing the non-edible parts of fish (head, tail, intestines, scales, etc.), washing, heat treatment, and packaging. During the preparation process, grilled fish loses moisture and water-soluble components, and as a result, yields become low and quality is prone to deterioration. When grilled fish is prepared using frozen fish, it is subjected to a thawing process. During the thawing process, moisture inside the fish excessively escapes, which reduces yield and tends to make the texture rough and hard. In addition, strong heat treatment is needed to ensure preservation, but strong heat treatment causes a significant decline in the quality of grilled fish, such as dry texture, off-flavor, etc.

Previously, Korean Patent No. KR 10-2320848 B1 discloses “a method of preparing grilled fish for convenient eating, and grilled fish for convenient eating which is prepared by the preparation method,” in which mackerel and Spanish mackerel fillets are soaked in a seasoning sauce, heat-treated using a superheated steam grill, and then frozen with an electromagnetic freezer. However, there is still an emerging need to develop a method of preparing grilled fish which is suitable for cold chain due to mass production while having high quality and high convenience.

### DISCLOSURE

### Technical Problem

The present disclosure provides a method of preparing grilled fish, and grilled fish with improved texture.

### Technical Solution

An object of the present disclosure is to provide a method of preparing grilled fish, the method including the steps of pretreating the fish with an alkaline agent containing sodium carbonate; heat-treating the pretreated fish; and cooling the heat-treated fish.

Another object of the present disclosure is to provide a composition for pretreating frozen fish, the composition including an alkaline agent containing sodium carbonate.

Still another object of the present disclosure is to provide grilled fish with improved texture, which is prepared by the above method.

### Advantageous Effects

The quality of grilled fish may greatly vary depending on a processing method. In the present disclosure, the water retention capacity is improved through pretreatment of raw materials, and among various heat treatment methods for grilling, a superheated steam heat treatment process that is excellent for securing appearance, texture quality, and microbial stability, and rapid cooling are applied to prepare grilled fish products with greatly improved yield and texture while securing a shelf life suitable for a storage method, in particular, cold chain. This may increase the company's financial value by improving product yields, and contribute to the development of the processed seafood industry and public health by providing high-quality grilled fish products for consumers.

### DETAILED DESCRIPTION OF PREFERRED EMBODIMENTS

The present disclosure will be described in detail as follows. Meanwhile, each description and embodiment disclosed in this disclosure may also be applied to other descriptions and embodiments. That is, all combinations of various elements disclosed in this disclosure fall within the scope of the present disclosure. Further, the scope of the present disclosure is not limited by the specific description described below.

Further, a number of papers and patent documents are referenced and cited throughout this specification. The disclosures of the cited papers and patent documents are incorporated herein by reference in their entirety to further clarify the level and scope of the subject matter to which the present disclosure pertains.

An aspect of the present disclosure provides a method of preparing grilled fish, the method including the step of pretreating the fish with an alkaline agent containing sodium hydrogen carbonate.

The method of preparing grilled fish of the present disclosure may include the steps of pretreating the fish with an alkaline agent containing sodium carbonate; heat-treating the pretreated fish; and cooling the heat-treated fish.

As used herein, the term “alkaline agent” refers to a basic substance that is soluble in water. In the present disclosure, the alkaline agent may be sodium carbonate, sodium hydrogen carbonate, or a combination thereof, but is not limited thereto. Any alkaline agent may be included without limitation, as long as it is an alkaline agent which may be used in foods.

The alkaline agent may include, for example, sodium metaphosphate, potassium metaphosphate, DL-malic acid, DL-sodium malate, acidic sodium aluminum phosphate, acidic sodium pyrophosphate, acidic calcium pyrophosphate, sodium sesquicarbonate, ammonium chloride, tribasic sodium phosphate, tribasic calcium phosphate, dibasic sodium phosphate, dibasic magnesium phosphate, dibasic ammonium phosphate, dibasic potassium phosphate, dibasic calcium phosphate, monobasic sodium phosphate, monobasic ammonium phosphate, monobasic potassium phosphate, monobasic calcium phosphate, potassium DL-bitartrate, potassium L-bitartrate, sodium carbonate, magnesium carbonate, sodium hydrogen carbonate, ammonium hydrogen carbonate, potassium hydrogen carbonate, ammonium carbonate, potassium carbonate, calcium carbonate, sodium polyphosphate, potassium polyphosphate, sodium pyrophosphate, potassium pyrophosphate, etc.

The alkaline agent may further include sodium hydrogen carbonate.

More specifically, the alkaline agent may be a combination of sodium carbonate and sodium hydrogen carbonate, wherein the ratio of sodium carbonate to sodium hydrogen carbonate may be 0.5:9.5, 1:9, 1.5:8.5, 2:8, 2.5:7.5, 3:7, 3.5:6.5, 4:6, 4.5:5.5, 5:5, 5.5:4.5, 6:4, 6.5:3.5, 7:3, 2.5:7.5, 8:2, 8.5:1.5, 9:1, or 9.5:0.5, but is not limited thereto.

In this regard, the alkaline agent may be used after being dissolved in a solvent, wherein the solvent may be water, and may be in the form of an aqueous alkaline solution, but the solvent is not limited as long as it is a solvent which may be used in general foods.

A pH of the aqueous alkaline solution may be 7.0 or higher, and the pH may be 8 to 12, specifically, 8.5 to 11.5.

Further, when the alkaline agent is used in an aqueous solution, its concentration may be 2% to 4% aqueous solution of 1.5 times to 2.5 times the weight of the raw material.

Further, the step of pretreating the fish may refer to pretreating frozen fish or unfrozen fish. More specifically, the fish may be frozen fish.

Further, the alkaline agent is used regardless of before or after thawing of frozen fish, preferably, used during the thawing process, but is not limited thereto.

The fish may include mackerel, Spanish mackerel, plaice, cutlassfish, Atka mackerel, saury, red fish, flatfish, tuna, cod, pollack, brown croaker, pomfret, dark-banded rockfish, tongue fish, salmon, rockfish, eel, red fish, horse mackerel, croaker, herring, etc., but is not limited thereto.

Further, the step of pretreating the fish includes methods which are used in the pretreatment process including the common thawing process, such as immersion, spraying, coating, injecting, tumbling, etc. of the fish using the solution containing the alkaline agent, but is not limited thereto.

In one specific embodiment of the present disclosure, the step of immersing and thawing the frozen fish in the aqueous solution containing the alkaline agent for about 30 minutes is included, but is not limited thereto.

In one exemplary embodiment of the present disclosure, it was confirmed that the pretreatment step with the alkaline agent achieved effects of low hardness, high moisture content, increased process yield, and excellent overall preference, resulting in the soft texture and excellent preference.

The method of preparing grilled fish of the present disclosure may further include a washing step after the pretreatment.

In this regard, the washing step may be performed using cooling water at 1 °C to 10 °C for 10 minutes to 20 minutes.

The method of preparing grilled fish of the present disclosure may further include a salting and/or seasoning process after the pretreatment step.

The heat treatment step is a step of heating the fish after the pretreatment step. The heat treatment may employ superheated steam, dry heat, moist heat, infrared radiation, etc., and may be specifically superheated steam heat treatment.

The temperature of the superheated steam heat treatment step may be 300 °C to 400 °C, 305 °C to 395 °C, 310 °C to 390 °C, 315 °C to 385 °C, 320 °C to 380 °C, 325 °C to 375 °C, 330 °C to 370 °C, 335 °C to 365 °C, 320 °C to 360 °C, 325 °C to 355 °C, or 320 °C to 350 °C, but is not limited thereto.

Further, the time condition may be 1 minute to 10 minutes, 1 minute 30 seconds to 9 minutes 30 seconds, 2 minutes to 9 minutes, 2 minutes 30 seconds to 8 minutes 30 seconds, 3 minutes to 8 minutes, 3 minutes 10 seconds to 7 minutes 50 seconds, 3 minutes 20 seconds to 7 minutes 40 seconds, 3 minutes 30 seconds to 7 minutes 30 seconds, 3 minutes 30 seconds to 7 minutes, 3 minutes 30 seconds to 6 minutes 30 seconds, 3 minutes 30 seconds to 6 minutes, 3 minutes 30 seconds to 5 minutes 30 seconds, 3 minutes 40 seconds to 5 minutes 20 seconds, 3 minutes 50 seconds to 5 minutes 10 seconds, 3 minutes 50 seconds to 5 minutes, or 4 minutes to 5 minutes, but is not limited thereto.

At this time, the core temperature of grilled fish may be about 70 °C to about 110 °C, about 75 °C to about 105 °C, about 80 °C to about 100 °C, about 81 °C to about 99 °C, about 82 °C to about 98 °C, about 83 °C to about 97 °C, about 84 °C to about 96 °C, or about 85 °C to about 95 °C, but is not limited to thereto.

The cooling step may be a step of cooling the grilled fish through natural cooling, gentle cooling (1 °C to 10 °C), or rapid cooling after the heat treatment step, and it may specifically refer to a rapid cooling step, but is not limited thereto.

The temperature condition of the rapid cooling step may be −1 °C to −40 °C, −5 °C to −35 °C, −10 °C to −30 °C, −13 °C to −27 °C, −15 °C to −25 °C, −15 °C to −23 °C, or −15 °C to −20 °C, but is not limited thereto.

Further, the time condition may be 1 minute to 20 minutes, 2 minutes to 18 minutes, 3 minutes to 17 minutes, 4 minutes to 16 minutes, 5 minutes to 15 minutes, 6 minutes to 14 minutes, 7 minutes to 13 minutes, 8 minutes to 12 minutes, or 9 minutes to 11 minutes, but is not limited thereto.

At this time, the core temperature of grilled fish may be about 0 °C to about 20 °C, about 1 °C to about 19 °C, about 2 °C to about 18 °C, about 3 °C to about 17 °C, about 4 °C to about 16 °C, about 5 °C to about 15 °C, about 6 °C to about 14 °C, about 7 °C to about 13 °C, or about 8 °C to about 12 °C, but is not limited to thereto.

Further, the method of preparing grilled fish may further include sealing and nitrogen filling packaging step, sterilization step, etc., after the heat treatment and cooling steps, but is not limited thereto.

The sealing and nitrogen filling packaging step is sufficient to pack the fish using a packaging film through nitrogen filling. Any method is sufficient as long as it may be generally used in the food field, and there is no particular limitation on the method.

Further, the sterilization step may be performed after the packaging step, and any method is also sufficient as long as it is a common method in the art, and there is no particular limitation. The grilled fish for convenient eating, which is packaged in this manner, may be stored for a long time under refrigeration.

In one exemplary embodiment of the present disclosure, it was confirmed that when the superheated steam heat treatment step is performed, the hardness was low and the moisture content was high, resulting in a soft texture and excellent preference.

It was also confirmed that the rapid cooling step exhibited a remarkable microbial control effect, as compared to gentle cooling of 4 °C.

Another aspect of the present disclosure provides a composition for pretreating frozen fish, the composition including an alkaline agent containing sodium carbonate.

The alkaline agent and the pretreatment are as described above.

The alkaline agent may further include sodium hydrogen carbonate.

Further, in the alkaline agent, a ratio of sodium carbonate:sodium hydrogen carbonate may be 2:8 to 8:2.

Still another aspect of the present disclosure provides grilled fish with improved texture, which is prepared by the above method.

The grilled fish may have hardness of 900 (g-force) to 1200 (g-force), 910 (g-force) to 1190 (g-force), 920 (g-force) to 1180 (g-force), 930 (g-force) to 1170 (g-force), 940 (g-force) to 1160 (g-force), 950 (g-force) to 1150 (g-force), 960 (g-force) to 1140 (g-force), 960 (g-force) to 1130 (g-force), 960 (g-force) to 1120 (g-force), 960 (g-force) to 1110 (g-force), 960 (g-force) to 1100 (g-force), 960 (g-force) to 1090 (g-force), 960 (g-force) to 1080 (g-force), 960 (g-force) to 1070 (g-force), 960 (g-force) to 1060 (g-force), or 960 (g-force) to 1050 (g-force), but is not limited thereto.

The hardness (g) is the force required to reach a predetermined deformation (force value of the highest peak in the graph), and may be measured by a texture analyzer (TA-XT plus, Stable Micro Systems, UK) under the following physical conditions.
Probe type: Warner-bratzler shear blade
Speed at which the probe descends on a sample (pre-test speed): 1.00 mm/sec
Speed at which the probe penetrates the sample after reaching the surface of the sample (test speed): 2.00 mm/sec
Speed at which the probe returns to its original position after penetrating the sample (post-test speed): 10.00 mm/sec
Distance through which the probe recognizes the surface of the sample and penetrates the sample (distance): 20.00 mm
Conditions for the probe to recognize the sample (trigger type): Auto (Force)
Minimum force required for the probe to recognize the presence of the sample (trigger force): 5.0 g

Further, the grilled fish may have a moisture content of 50% to 70%, 52% to 66%, or 54% to 64%, specifically, 54%, 55%, 56%, 57%, 58%, 59%, 60%, 61%, 62%, 63%, 64%, but is not limited thereto.

In one exemplary embodiment of the present disclosure, it was confirmed that the grilled fish which is prepared by the method of preparing grilled fish of the present disclosure has lower hardness, as compared to other commercially available refrigerated or frozen grilled fish, and thus it is soft and has the high moisture content to exhibit a moist texture and excellent overall preference, and accordingly, it was confirmed that the grilled fish is a high-quality grilled fish product while being suitable for cold chain through mass production.

Still another aspect of the present disclosure provides use of the composition including the alkaline agent containing sodium carbonate in the pretreatment of frozen fish.

The alkaline agent and the pretreatment are as described above.

The alkaline agent may further include sodium hydrogen carbonate.

Further, in the alkaline agent, a ratio of sodium carbonate:sodium hydrogen carbonate may be 2:8 to 8:2.

Still another aspect of the present disclosure provides use of the pretreatment composition including the alkaline agent containing sodium carbonate in the preparation of grilled fish with improved texture. The alkaline agent and the pretreatment are as described above.

The alkaline agent may further include sodium hydrogen carbonate.

Further, in the alkaline agent, a ratio of sodium carbonate:sodium hydrogen carbonate may be 2:8 to 8:2.

### MODE FOR CARRYING OUT THE INVENTION

Hereinafter, the present disclosure will be described in more detail by way of exemplary embodiments. However, the following exemplary embodiments are only preferred embodiments for illustrating the present disclosure, and thus are not intended to limit the scope of the present disclosure thereto. Meanwhile, technical matters not described in the present specification may be sufficiently understood and easily implemented by those skilled in the technical field of the present disclosure or similar technical fields.

### Experimental Materials

The fish used in experiments was frozen Norwegian mackerel fillet from which the head, tail, intestines, and scales were removed, and purchased from a Chinese seafood processing company (Qingdao Yihexing Foods Co., Ltd.) and stored frozen at −25 °C until the experiment.

### Preparation Example 1. Pretreatment Step of Fish Using Alkaline Agent

Sodium hydrogen carbonate (NaHCO₃) and sodium carbonate (Na₂CO₃) which were used to examine the effect of alkaline pretreatment were provided by SJD Co., Ltd., and phosphate (polymix CS) purchased from Seodo BNI Co., Ltd. was used.

To examine the effect of improving the water retention capacity of raw materials when applying three types of alkaline pretreatment agents, a control group was immersed and thawed in water at room temperature for 30 minutes, and experimental groups were immersed and thawed in 3% sodium carbonate, 3% sodium hydrogen carbonate, and 3% phosphate solutions, respectively, for 30 minutes. In addition, in order to examine the synergistic effect when the two top-ranked materials showing the effect of improving water retention capacity were used in combination, thawing was performed for 30 minutes by immersing in 3% solution of sodium carbonate and sodium hydrogen carbonate at a ratio of 7:3, 5:5, or 3:7, which are the two top-ranked materials confirmed in the previous experiment. The ratio of the thawed raw material and the alkaline pretreatment mixture was adjusted to 1:2.

### Preparation Example 2. Superheated Steam Heat Treatment Step of Grilled Fish

In order to compare the quality of grilled fish products between heat treatment sources mainly used for grilled fish and heat treatment in a superheated steam oven, the salted raw materials were heated in a superheated steam oven (QF-5100CB, Naomoto Co., Ltd., Japan), an infrared oven (UH-DORI JC-9282, JC Electric Co., Ltd., Korea), a moist heat oven (Air-O-Steam combination oven (268783), Electrolux Co., Ltd., Sweden), and a dry heat oven (Impinger II onveyor oven, Lincoln Co., Ltd., USA) under conditions of Table 1 so that the core material temperature was 85 °C or higher.

TABLE 1

| | Heat treatment | Heat treatment | Heat treatment |
|---|---|---|---|
| | method | time | temperature (°C) |
| 1 | Superheated steam | 4 min 30 sec | Temperature inside oven: |
| | | | 250 °C, Superheated steam |
| | | | temperature: 350 °C |
| 2 | Dry heat oven | 6 min 30 sec | 250 °C |
| 3 | Moist heat oven | 7 min 30 sec | 250 °C, 100% steam |
| 4 | Infrared oven | 11 min | — |

### Preparation Example 3. Rapid Cooling Step of Grilled Fish

In order to examine the microbial control effect of rapid cooling versus gentle cooling in the cooling process after heat treatment of grilled fish, the control group (gentle cooling) was cooled at 4 °C for 60 minutes, and the experimental groups (rapid cooling) were cooled at −20 °C for 11 minutes, based on the core temperature of 10 °C or lower, and then sealed and packed with nitrogen, and stored at 15 °C.

### Experimental Example 1. Verification of Quality Improvement Effect of Thawing Raw Mackerel Using Alkaline Pretreatment Agent

In order to examine the effect of improving water retention capacity according to the pretreatment with the alkaline agent and the mixing concentration during preparation of grilled fish, samples were prepared by the method of Preparation Example 1, and after the same salt immersing-heating-cooling processes, the samples were prepared in the form of final grilled products, on which process yield, physical properties, and moisture content were examined and sensory evaluation was performed.

### Experimental Example 1-1. Measurement of Pretreatment Process Yield

To measure the process yield, the weight of the raw material before thawing was measured, and then the measured weight of each grilled product prepared by the method of Preparation Example 1 was divided by the initial weight to calculate the process yield (%).

As a result of measuring the process yield of grilled mackerel which was pretreated with alkaline, the process yield of the raw material immersed in the aqueous alkaline solution tended to increase, as compared to that of the untreated group which was thawed and immersed in water.

Among them, the process yield of the grilled mackerel immersed in 3% sodium carbonate was 80.5%, which is an increase of 3.6 percentage points, as compared to 76.9% of the process yield of the untreated group, exhibiting the largest increase in the yield.

In addition, among the three treatment groups, sodium carbonate and sodium hydrogen carbonate, which showed a high overall preference in sensory evaluation, were mixed at a ratio of 7:3, 3:7, or 5:5, respectively, and the process yield was measured, and as a result, the process yield of grilled fish which was subjected to alkaline pretreatment with the mixture showed the high process yield, as compared to single treatment of the grilled fish. Among them, when the ratio of sodium carbonate and sodium hydrogen carbonate was 7:3, the highest process yield of 81.42% was confirmed.

TABLE 2

| | | | | | Sodium | | |
|---|---|---|---|---|---|---|---|
| | | | Sodium | | carbonate:Sodium | | |
| | | Sodium | hydrogen | | hydrogen carbonate | | |
| | Untreated | carbonate | carbonate | Phosphate | 7:3 | 3:7 | 5:5 |
| Process | 76.90 | 80.51 | 78.43 | 78.89 | 81.42 | 81.29 | 80.67 |
| yield (%) | | | | | | | |

In other words, the effect of increasing the process yield of the grilled fish through pretreatment with the alkaline agent was confirmed.

### Experimental Example 1-2. Analysis of Physical Property (Hardness) (Rupture Test)

Hardness of the grilled mackerel prepared through alkaline pretreatment using the method of Preparation Example 1 was measured by the following method.

For analysis of the physical property, the sample was cut into 4 cm in width and 1 cm in length as uniformly as possible, and then the hardness was measured through a rupture test using a texture analyzer (TA-XT plus, Stable Micro Systems, UK) under refrigerated conditions. A total of 10 measurements were performed under the same conditions, and the average value was taken as the result. The probe of the texture analyzer descends vertically on the sample at a controlled distance and speed. After the probe descends at the controlled distance, the probe rises by the adjusted distance and speed. Through this series of processes, a force-perceiving device and transducer recognize the force applied to the measurement sample and transmit the data (force value, operating time, probe movement distance) to the computer. Definitions of the terms with regard to the measurement of physical property and conditions for the measurement of physical property are as follows.
(1) Hardness (g): force required to reach a predetermined deformation (force value of the highest peak in the graph)
(2) Conditions for measurement of physical property:
   Probe type: Warner-bratzler shear blade
   Speed at which the probe descends on a sample (pre-test speed): 1.00 mm/sec
   Speed at which the probe penetrates the sample after reaching the surface of the sample (test speed): 2.00 mm/sec
   Speed at which the probe returns to its original position after penetrating the sample (post-test speed): 10.00 mm/sec
   Distance through which the probe recognizes the surface of the sample and penetrates the sample (distance): 20.00 mm
   Conditions for the probe to recognize the sample (trigger type): Auto (Force)
   Minimum force required for the probe to recognize the presence of the sample (trigger force): 5.0 g

As a result, as shown in Table 3 below, the hardness of the grilled mackerel was 1234.5 g-force, 1007.5 g-force, 1030.6 g-force, and 1043.9 g-force for the untreated group, sodium carbonate-treated group, sodium hydrogen carbonate-treated group, and phosphate-treated group, respectively, confirming that the grilled mackerel subjected to alkaline treatment had the lower hardness than the untreated group.

Among them, the grilled mackerel pretreated with sodium carbonate showed the hardness of 1007.5, indicating the softest texture, and it was confirmed that the alkaline pretreatment process improved the texture of grilled fish.

TABLE 3

| | | | Sodium | |
|---|---|---|---|---|
| | | Sodium | hydrogen | |
| | Untreated | carbonate | carbonate | Phosphate |
| Hardness | 1234.50 | 1007.47 | 1030.59 | 1043.88 |
| (g-force) | | | | |

### Moisture Content Analysis

For moisture content analysis, the sample was finely ground, 3 g thereof was taken, and then the moisture content was measured by heating and drying methods according to the AMERICAN ASSOCIATION OF CEREAL CHEMISTS (AACC) (44-16) method.

As a result of measuring the moisture content of grilled mackerel prepared through alkaline pretreatment, it was found that the moisture content of grilled mackerel prepared through alkaline pretreatment was higher than that of the untreated group, indicating a moist texture. In particular, the moisture content of the sodium carbonate-treated group was 63.22%, which was 3.89% p higher than that of the untreated group (59.33%).

TABLE 4

| | | | Sodium | |
|---|---|---|---|---|
| | | Sodium | hydrogen | |
| | Untreated | carbonate | carbonate | Phosphate |
| Water | 59.33 | 63.22 | 62.28 | 61.28 |
| content (%) | | | | |

### Sensory Evaluation

For the sensory evaluation, five trained panelists were asked to taste each refrigerated grilled fish product after cooking it in a microwave for 1 minute. After each sample, they rinsed their mouths with water, and after 1 minute, allowed to taste the next sample. The intensity and preference of texture, overall taste preference, and comprehensive preference were evaluated, and the results were expressed on a 5-point scale, and the standards are shown in Table 5.

TABLE 5

5-point scale

| | 1 | 2 | 3 | 4 | 5 |
|---|---|---|---|---|---|
| Intensity | Very soft | Soft | Fair | firm | Very firm |
| Preference | Very bad | Bad | Fair | Good | Very good |

As a result of the sensory evaluation of the grilled mackerel prepared according to the method of Experimental Example 1, the grilled mackerel treated with sodium carbonate showed the lowest texture intensity of 2.2, the grilled mackerel treated with sodium hydrogen carbonate showed the texture intensity of 2.6, and the grilled mackerel treated with phosphate showed the texture intensity of 3.2, confirming that the texture intensity of the alkaline pretreated groups was softer than the texture intensity (3.4) of the untreated grilled mackerel. Regarding the texture preference, the sodium carbonate-treated group showed the highest preference of 4.4.

In addition, the overall taste preference (4.4 for sodium carbonate, 4.0 for sodium hydrogen carbonate) and comprehensive taste preference (4.4 for sodium carbonate, 4.0 for sodium hydrogen carbonate) of the alkaline-pretreated groups were superior to the overall taste preference of 3.0 and the comprehensive taste preference of 3.2 of the untreated group.

In other words, the above results confirmed that the preference of grilled fish was improved by the pretreatment with the alkaline agent.

TABLE 6

| | | | Sodium | |
|---|---|---|---|---|
| | | Sodium | hydrogen | |
| | Untreated | carbonate | carbonate | Phosphate |
| Texture intensity | 3.4 | 2.2 | 2.6 | 3.2 |
| Texture preference | 3.2 | 4.4 | 3.6 | 2.8 |
| Overall taste | 3.0 | 4.4 | 4.0 | 3.4 |
| preference | | | | |
| Comprehensive | 3.2 | 4.4 | 4.0 | 3.4 |
| preference | | | | |

### Experimental Example 2. Verification of Effect of Heat Treatment Process of Grilled Fish in Superheated Steam Oven

In order to examine the effect of a heat source of a superheated steam oven during heat treatment of grilled mackerel, the moisture content, sensory quality, and physical properties of the samples prepared by the method of Preparation Example 2 were examined, and the three analysis indicators were measured in the same manner as in Experimental Example 1.

### Experimental Example 2-1. Examination of Hardness of Grilled Fish According to Heat Treatment Method

The grilled fish pretreated in the same manner as in Preparation Example 1 was treated with superheated steam, moist heat, dry heat, and infrared heat according to each heat source using the method of Preparation Example 2, and then hardness was analyzed in the same manner as in Experimental Example 1. As a result, it was found that the hardness of grilled mackerel heat-treated using the superheated steam method was 912 g-force, showing the softest texture.

TABLE 7

| | Superheated | Moist | Dry | Infrared |
|---|---|---|---|---|
| | steam | heat | heat | heat |
| Hardness | 912 | 1,418 | 1,526 | 1,633 |
| (g-force) | | | | |

### Experimental Example 2-2. Examination of Moisture Content of Grilled Fish According to Heat Treatment Method

As a result of measuring the moisture content of grilled fish according to the heat sources, the grilled mackerel heat-treated with infrared had the lowest moisture content of 46.3%, and the grilled fish heat-treated in the superheated steam oven had the highest moisture content of 54.1%. The grilled fish heat-treated in the moist heat oven and the dry heat oven had the moisture content of 53.7% and 53.6%, respectively.

The results of hardness and moisture content confirmed that grilled fish heat-treated in the superheated steam oven had a soft texture due to low hardness, although there was no large difference in the moisture content, as compared to the grilled fish heat-treated in the moist heat oven or dry heat oven.

TABLE 8

| | Superheated | Moist | Dry | Infrared |
|---|---|---|---|---|
| | steam | heat | heat | heat |
| Moisture | 54.1 | 53.7 | 53.6 | 46.3 |
| content (%) | | | | |

### Experimental Example 2-3. Sensory Evaluation of Grilled Fish According to Heat Treatment Method

Sensory evaluation was conducted on grilled mackerel prepared by heat treatment using the method of Experimental Example 2.

As a result, the grilled mackerel heat-treated in the superheated steam oven had the lowest texture intensity of 2.6, and the grilled mackerel heat-treated in the dry heat oven had the highest texture intensity of 4.0.

The mackerel heat-treated in the superheated steam oven had the highest texture preference of 4.8. In addition, the overall taste preference of the group treated in the superheated steam oven was 4.6, which was superior to the overall taste preference of those treated in the moist heat oven, dry heat oven, and infrared oven. The comprehensive preference of those treated in the superheated steam oven was 4.8, which was also superior to the comprehensive preference of those treated in the moist heat oven, dry heat oven, and infrared oven.

The above results confirmed that those heat-treated with superheated steam were soft due to the low texture intensity while being moist and having the high texture preference due to the high moisture content.

TABLE 9

| | Superheated | Moist | Dry | Infrared |
|---|---|---|---|---|
| | steam | heat | heat | heat |
| Texture intensity | 2.6 | 3.0 | 4.0 | 3.8 |
| Texture preference | 4.8 | 3.4 | 3.2 | 2.6 |
| Overall taste | 4.6 | 3.2 | 3.4 | 3.2 |
| preference | | | | |
| Comprehensive | 4.8 | 3.4 | 3.2 | 3.2 |
| preference | | | | |

### Experimental Example 3. Verification of Microbial Control Effect of Rapid Cooling Stage on Grilled Fish

For microbial analysis of general bacteria and coliforms, 20 g to 30 g of the sample was collected, and diluted 10 times with saline, and 4-log dilution was performed by applying 1 mL thereof to a petrifilm (Aerobic count plate (AC (for general bacteria))/Coliform Count (CC (for coliforms)), 3M, USA).

The grilled mackerels prepared under equal conditions of pretreatment with the alkaline agent using the method of Preparation Example 1 and heat-treatment using the method of Preparation Example 2 were subjected to gentle cooling or rapid cooling using the method of Preparation Example 3, and analyzed for general bacteria and coliforms.

As a result, in the grilled fish subjected to rapid cooling, no general bacteria and no coliforms were detected until 20 days under 15 °C storage conditions. In the grilled fish subjected to gentle cooling, no coliforms were detected until 13 days under refrigerated storage conditions, but 5.0×10 CFU/g of general bacteria was detected on day 1, and 8.08×10⁴ of general bacteria were detected on day 13 of refrigeration, indicating that the shelf life of the grilled mackerel subjected to gentle cooling will not exceed two weeks.

TABLE 10
Number of microorganisms in grilled fish after gentle cooling

| Gentle | | | | | | |
|---|---|---|---|---|---|---|
| cooling | | | | | | |
| (date) | Initial | +1 | +2 | +3 | +6 | +13 |
| General | N.D. | 5.0 × 10⁰ | 5.0 × 10⁰ | 3.47 × 10² | 5.25 × 10² | 8.08 × 10⁴ |
| bacteria | | | | | | |
| (CFU/g) | | | | | | |
| Coliforms | N.D. | N.D. | N.D. | N.D. | N.D. | N.D. |
| (CFU/g) | | | | | | |

TABLE 11
Number of microorganisms in grilled fish after rapid cooling

| Rapid | | | | | | |
|---|---|---|---|---|---|---|
| cooling | | | | | | |
| (date) | Initial | +3 | +6 | +8 | +10 | +14 |
| General | N.D. | N.D. | N.D. | N.D. | N.D. | N.D. |
| bacteria | | | | | | |
| (CFU/g) | | | | | | |
| Coliforms | N.D. | N.D. | N.D. | N.D. | N.D. | N.D. |
| (CFU/g) | | | | | | |

### Experimental Example 4. Quality Comparison with Commercially Available Refrigerated and Frozen Grilled Fish

In order to compare the quality between refrigerated grilled fish prepared through the series of processes of Preparation Examples and commercially available refrigerated/frozen grilled fish, moisture content, sensory, and physical properties were examined, and the three analysis indicators were measured in the same manner as in Experimental Example 1.

Mackerel treated by the method of Preparation Example 1 was prepared through rapid cooling after heat treatment in the superheated steam oven, and the quality was compared (Preparation Example).

As a result, the hardness of the grilled mackerel of Preparation Example was 975.6 g-force, showing the softest texture, the hardness of the frozen grilled mackerel of ‘O’ company was 1465.8 g-force, and the hardness of the refrigerated grilled mackerel of ‘S’ company was 1648.7.

TABLE 12
Comparison of hardness with commercially
available grilled fish products

| | Preparation | ‘O’ company | ‘S’ company |
|---|---|---|---|
| | Example | (frozen) | (refrigerated) |
| Hardness | 975.6 | 1465.8 | 1648.7 |
| (g-force) | | | |

As a result of comparative analysis of the moisture content using the method of Experimental Example, the moisture content of the grilled mackerel of Preparation Example was 56.44%, indicating that the moisture content was higher than those of other commercially available grilled mackerel products. The moisture content of the frozen grilled mackerel of ‘O’ company was 49.44%, and the moisture content of the refrigerated grilled mackerel of ‘S’ company was 51.67%.

TABLE 13

| | Preparation | ‘O’ company | ‘S’ company |
|---|---|---|---|
| | Example | (frozen) | (refrigerated) |
| Moisture | 56.44 | 49.44 | 51.67 |
| content (%) | | | |

As a result of the sensory evaluation using the method of Experimental Example, the grilled mackerel of Preparation Example had the texture intensity of 2.5, indicating the lowest texture intensity, as compared to 2.7 of ‘O’ company and 3.7 of ‘S’ company, and had the high texture preference. The grilled mackerel of Preparation Example also had the highest overall taste preference of 4.5, as compared to 3.8 of ‘O’ company and 2.3 of ‘S’ company. The grilled mackerel of Preparation Example also had the highest comprehensive preference of 4.7, as compared to 3.8 of ‘O’ company and 2.5 of ‘S’ company, indicating superior sensory quality.

TABLE 14

| | Preparation | ‘O’ company | ‘S’ company |
|---|---|---|---|
| | Example | (frozen) | (refrigerated) |
| Texture intensity | 2.5 | 2.7 | 3.7 |
| Texture preference | 4.5 | 3.8 | 2.8 |
| Overall taste | 4.5 | 3.8 | 2.3 |
| preference | | | |
| Comprehensive | 4.7 | 3.8 | 2.5 |
| preference | | | |

The above results confirmed that the grilled fish prepared by the method of the present disclosure has excellent sensory quality while being suitable for cold chain due to mass production.

Based on the above description, it will be understood by those skilled in the art that the present disclosure may be implemented in a different specific form without changing the technical spirit or essential characteristics thereof. In this regard, it should be understood that the above embodiment is not limitative, but illustrative in all aspects. The scope of the disclosure is defined by the appended claims rather than by the description preceding them, and therefore all changes and modifications that fall within metes and bounds of the claims, or equivalents of such metes and bounds are therefore intended to be embraced by the claims.

1. A method of preparing grilled fish, the method comprising
pretreating the fish with an alkaline agent including sodium carbonate;
heat-treating the pretreated fish; and
cooling the heat-treated fish.

2. The method of claim 1, wherein the alkaline agent further includes sodium hydrogen carbonate.

3. The method of claim 2, wherein a ratio of sodium carbonate:sodium hydrogen carbonate in the alkaline agent is 2:8 to 8:2.

4. The method of claim 1, wherein the pretreatment of the fish is a method of thawing frozen fish by immersion, spraying, coating, injecting, or tumbling using an alkaline solution.

5. The method of claim 1, further comprising the step of washing out the pretreatment agent, after pretreatment of the fish.

6. The method of claim 1, wherein the heat treatment is a superheated steam heat treatment.

7. The method of claim 6, wherein the superheated steam heat treatment step is performed at 320 °C to 365 °C for 3 minutes 50 seconds to 5 minutes 50 seconds at a core temperature of 80 °C to 95 °C.

8. The method of claim 1, wherein the cooling step is performed at −10 °C to −30 °C for 5 minutes to 15 minutes at a core temperature of 0 °C to 15 °C.

9. The method of claim 1, wherein the grilled fish is grilled fish distributed under refrigeration.

10. A composition for pretreating frozen fish, the composition comprising an alkaline agent including sodium carbonate.

11. The composition of claim 10, wherein the alkaline agent further includes sodium hydrogen carbonate.

12. The composition of claim 11, wherein a ratio of sodium carbonate:sodium hydrogen carbonate in the alkaline agent is 2:8 to 8:2.

13. Grilled fish with improved texture, which is prepared by the method of claim 1.

14. The grilled fish of claim 13, wherein the grilled fish has hardness of 900 (g-force) to 1200 (g-force) and a moisture content of 54% to 64%.

15. (canceled)
